(19) United States
(12) Patent Application Publication
(10) Pub. No.: US 2015/0380736 A1
(43) Pub. Date: Dec. 31, 2015

(54) COMPOSITE CATHODE ACTIVE MATERIAL, CATHODE AND LITHIUM BATTERY INCLUDING THE MATERIAL, AND METHOD OF PREPARING THE MATERIAL

(71) Applicant: SAMSUNG SDI CO., LTD., Yongin-si (KR)

(72) Inventors: Youngjin Park, Yongin-si (KR); Dohyung Park, Yongin-si (KR); Kwanghwan Cho, Yongin-si (KR); Kihyun Kim, Yongin-si (KR); Minhan Kim, Yongin-si (KR); Sun-Ho Kang, Yongin-si (KR)

(21) Appl. No.: 14/703,777

(22) Filed: May 4, 2015

(30) Foreign Application Priority Data
Jun. 30, 2014 (KR) 10-2014-0081209

(51) Int. Cl. H01M 4/485; H01M 4/505; H01M 4/525; H01M 4/48; H01M 10/052

(52) U.S. Cl. CPC H01M 4/485; H01M 4/483; H01M 10/052; H01M 4/525; H01M 4/505; H01M 2004/028

(57) ABSTRACT

A composite cathode active material including a lithium transition metal oxide, wherein the lithium transition metal oxide includes a layered structural phase and a spinel structural phase, and an amount of residual lithium is about 0.30 wt % or less; a cathode and a lithium battery including the composite cathode active material; and a method of preparing the composite cathode active material.

### CROSS-REFERENCE TO RELATED APPLICATION

This application claims priority to and the benefit of Korean Patent Application No. 10-2014-0081209, filed on Jun. 30, 2014, in the Korean Intellectual Property Office, the entire content of which is incorporated herein by reference.

### BACKGROUND

1. Field

One or more embodiments relate to a composite cathode active material, a cathode and a lithium battery including the composite cathode active material, and a method of preparing the composite cathode active material.

2. Description of the Related Art

In line with miniaturization and manufacturing of high-performance devices, demand for lithium batteries having a high energy density has increased as well as demand for small and light-weight batteries. In addition, as it pertains to the manufacture of electric vehicles and batteries for the same, stability of a lithium battery has been regarded as an important criterion.

It is desirable to have cathode active materials suitable to manufacture a lithium battery satisfying the characteristics described above.

A volume of a lithium transition metal oxide having a layered structure varies with intercalation and deintercalation of lithium ions. However, when an excess amount of lithium ions is deintercalated (depending on the particular lithium transition metal oxide layered structure), a crystalline structure of the lithium transition metal oxide may be destructed, and thus stability of the lithium battery may deteriorate. As a result, cycle life characteristics of the lithium battery may deteriorate.

Therefore, it is desirable to have a method for improving cycle life characteristics of a lithium battery by including a lithium transition metal oxide having a layered structure with improved structural stability.

### SUMMARY

One or more aspects of one or more embodiments are directed to a composite cathode active material including a layered structural phase and a spinel structural phase, wherein an amount of residual lithium in the lithium transition metal oxide is about 0.30 wt % or less.

In some embodiments, an X-ray diffraction spectrum of the lithium transition metal oxide shows a first peak at a diffraction angle (2θ) of about 35° to about 37° corresponding to the spinel structural phase.

In some embodiments, an amount of the spinel structural phase is about 5.0 vol % with respect to the total volume of crystalline structural phase.

In some embodiments, an amount of the spinet structural phase is about 0.5 vol % to about 5.0 vol % with respect to the total volume of crystalline structural phase.

In some embodiments, an amount of the spinel structural phase is about 0.6 vol % to about 3.5 vol % with respect to the total volume of crystalline structural phase.

In some embodiments, the spinel structural phase is formed by phase transitioning the layered structural phase.

In some embodiments, the phase transitioning is performed by heat-treating the layered structural phase.

In some embodiments, the amount of residual lithium in the lithium transition metal oxide is about 0.28 wt % or less.

In some embodiments, the amount of residual lithium in the lithium transition metal oxide is about 0.25 wt % or less.

In some embodiments, the lithium transition metal oxide is represented by Formula 1: Formula 1 LiₐMO_{2+α}. In Formula 1, 0.9<a≦1.1 and −0.1≦α≦0.1; and M is at least one element selected from the group consisting of Ni, Co, Mn, Fe, V, Cu, Cr, Al, Mg, Ti, Ca, Mg, Al, Sr, Zn, Y, Zr, Nb, and B.

In some embodiments, the lithium transition metal oxide comprises nickel in an amount higher than any other transition metal in the lithium transition metal oxide.

In some embodiments, the lithium transition metal oxide is represented by Formula 2: Formula 2 Liₐ[NiₓM′_{b}]O_{2+α}. In Formula 2, 0.9<a≦1.1, 0.6≦x<1, 0<b≦0.4, x+y=1, and −0.1≦α≦0.1; and M′ is at least one selected from the group consisting of Co, Mn, Fe, V, Cu, Cr, Al, Mg, Ti, Ca, Mg, Al, Sr, Zn, Y, Zr, Nb, and B.

In some embodiments, the lithium transition metal oxide is represented by Formula 3: Formula 3 Liₐ[NiₓCo_{y}Al_{z}A_{w}]O_{2+α}. In Formula 3, 0.9<a≦1.1, 0.6≦<1, 0<y≦0.4, 0<z≦0.4, 0≦w<0.05, x+y+z+w=1, and −0.1≦α≦0.1; and A is at least one selected from the group consisting of Fe, V, Cu, Cr, Mn, Mg, Ti, Ca, Mg, Al, Sr, Zn, Y, Zr, Nb, and B.

In some embodiments, the lithium transition metal oxide is represented by Formula 4: Formula 4 Liₐ[NiₓCo_{y}Al_{z}]O₂. In Formula 4, 0.9<a≦1.1, 0.8≦x<1, 0<y≦0.4, 0<z≦0.4, and x+y+z+w=1.

One or more aspects of one or more embodiments are also directed to a cathode comprising the composite cathode active material.

One or more aspects of one or more embodiments are also directed to a lithium battery comprising the cathode.

One or more aspects of one or more embodiments are also directed to a method of preparing a composite cathode active material. The method includes preparing a lithium transition metal oxide having a layered structure and heat-treating the lithium transition metal oxide to provide the composite cathode active material, the composite cathode active material including a lithium transition metal oxide having a layered structural phase and a spinal structural phase.

In some embodiments, the lithium transition metal oxide is heat-treated at a temperature of about 600° C. to about 900° C.

In some embodiments, the lithium transition metal oxide is heat-treated for about 5 hours to about 25 hours.

In some embodiments, the lithium transition metal oxide is heat-treated in an oxidative atmosphere.

### BRIEF DESCRIPTION OF THE DRAWINGS

These and/or other aspects will become apparent and more readily appreciated from the following description of the embodiments, taken in conjunction with the accompanying drawings in which:

FIG. 1 is an XRD spectrum of composite cathode active materials prepared in Examples 1, 3 and 5 and Comparative Example 1;

FIG. 2 shows life characteristics experiment results of lithium batteries prepared in Examples 6, 8 and 10 and Comparative Example 2; and

FIG. 3 is a schematic view of a lithium battery according to an exemplary embodiment.

### DETAILED DESCRIPTION

Reference will now be made in more detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Further, the use of “may” when describing embodiments of the inventive concept refers to “one or more embodiments of the inventive concept.” Also, the term “exemplary” is intended to refer to an example or illustration.

Additionally, as used herein, the term “substantially,” “about,” and similar terms are used as terms of approximation and not as terms of degree, and are intended to account for the inherent deviations in measured or calculated values that would be recognized by those of ordinary skill in the art.

Hereinafter, a composite cathode active material according to an exemplary embodiment, a cathode and a lithium battery each including the composite cathode active material, and a method of preparing the composite cathode active material will be described in detail in one or more embodiments.

A composite cathode active material according to an exemplary embodiment includes a lithium transition metal oxide. The lithium transition metal oxide includes a layered structural phase and a spinel structural phase, and an amount of residual lithium in the lithium transition metal oxide is about 0.30 wt % or less. The term “spinel structural phase” as used herein refers to a phase that includes both a spinel-crystalline structure and a spinel-like crystalline structure (i.e., a crystalline structure that is similar to a spinel-crystalline structure). For example, the spinel phase includes structural domains that crystallize in a cubic (isometric) crystal system with oxide anions arranged in a cubic close-packed lattice and cations occupying some or all of octahedral and/or tetrahedral sites in the lattice. The relative extent to which spinel phase (i.e., the phase including the spinel-crystalline structure and a spinel-like crystalline structure) can be determined by obtaining an X-ray diffraction (XRD) spectrum of the lithium transition metal oxide and identifying diffraction angle peaks characteristic of spinel- and spinel-like-crystalline structures.

Since the lithium transition metal oxide includes a composite of a layered structure and a spinel structure, structural stability of the lithium transition metal oxide may be improved. Accordingly, in some embodiments, a lithium battery including the composite cathode active material may have improved cycle life characteristics. Non-limiting examples of the transition metal of the lithium transition metal oxide according to embodiments of the present invention include Groups 3 to Group 12 transition metal elements in the periodic table and Groups 13 to Group 15 metalloid elements in the periodic table.

The lithium transition metal oxide may have a first peak that corresponds to the spinel structural phase, which is observed at a diffraction angle (2θ) of from about 35° to about 37° in an X-ray diffraction spectrum.

An amount of the spinel structural phase in the lithium transition metal oxide, which may be calculated from a first (leftmost) peak in the XRD spectrum, may be about 5.0 vol % based on the total amount of the crystalline structural phase. That is, a volume occupied by the spinet structural phase may be about 5% or less based on the total volume of the lithium transition metal oxide. For example, an amount of the spinel structural phase in the lithium transition metal oxide may be of from about 0.5 vol % to about 5.0 vol % based on a total volume of the crystalline structural phase. For example, an amount of the spinet structural phase in the lithium transition metal oxide may be of from about 0.6 vol % to about 3.5 vol % based on the total volume of the crystalline structural phase. For example, an amount of the spinel structural phase in the lithium transition metal oxide may be of from about 0.6 vol % to about 2.0 vol % based on the total amount of the crystalline structural phase. According to some embodiments, when an amount of the spinel structural phase exceeds or falls below a particular amount, cycle life characteristics of the lithium battery may deteriorate.

In the composite cathode active material according to some embodiments, the spinel structural phase may be formed from the layered structural phase by phase transition. The phase transition may be performed by heat-treating the layered structural phase.

In the composite cathode active material, an amount of residual lithium (e.g., an amount of lithium that is not part of the spinel structural phase and is not part of the layered structural phase) included in the lithium transition metal oxide may be about 0.28 wt % or less. For example, in the composite cathode active material, an amount of residual lithium included in the lithium transition metal oxide may be about 0.25 wt % or less. When an amount of the residual lithium is exceeds or falls below a particular amount, cycle life characteristics of the lithium battery may deteriorate due to increased side reactions between the cathode active material and the electrolyte.

The lithium transition metal oxide in the composite cathode active material may be represented by Formula 1:

LiₐMO_{2+α}. Formula 1

In Formula 1, 0.9<a≦1.1 and −0.1≦α≦0.1; and M may include at least one element selected from Ni, Co, Mn, Fe, V, Cu, Cr, Al, Mg, Ti, Ca, Mg, Al, Sr, Zn, Y, Zr, Nb, and B.

In some embodiments, in the lithium transition metal oxide of the composite cathode active material, an amount of the nickel is higher than an amount of one or more additional transition metal that may be included in the lithium transition metal oxide, based on the atomic fraction of nickel with respect to other transition metals. For example, the lithium transition metal oxide may be a nickel-based lithium transition metal oxide. For example, the lithium transition metal oxide may include a plurality of transition metals, wherein an amount of nickel (based on the atomic fraction thereof) among the transition metals is the highest.

For example, the lithium transition metal oxide in the composite cathode active material may be represented by Formula 2:

Liₐ[NiₓM′_{b}]O_{2+α} Formula 2

In Formula 2, 0.9<a≦1.1, 0.6≦x<1, 0<b≦0.4, x+y=1, and −0.1≦α≦0.1; and M′ may include at least one element selected from Co, Mn, Fe, V, Cu, Cr, Al, Mg, Ti, Ca, Mg, Al, Sr, Zn, Y, Zr, Nb, and B.

For example, the lithium transition metal oxide in the composite cathode active material may be represented by Formula 3:

Liₐ[NiₓCO_{y}Al_{z}A_{w}]O_{2+α} Formula 3

In Formula 3, 0.9<a≦1.1, 0.6≦x<1, 0<y≦0.4, 0<z≦0.4, 0≦w<0.05, x+y+z+w=1, and −0.1≦α≦0.1; and A may include at least one element selected from Fe, V, Cu, Cr, Mn, Mg, Ti, Ca, Mg, Al, Sr, Zn, Y, Zr, Nb, and B.

For example, the lithium transition metal oxide in the composite cathode active material may be represented by Formula 4:

Liₐ[NiₓCo_{y}Al_{z}]O₂. Formula 4

In Formula 4, 0.9<a≦1.1, 0.8≦x<1, 0<y≦0.4, 0<y≦0.4, and x+y+z=1.

For example, the lithium transition metal oxide in the composite cathode active material may be represented by Formula 5:

Liₐ[NiₓCo_{y}Mn_{z}]O₂. Formula 5

In Formula 5, 0.9<a≦1.1, 0.8≦x<1, 0<y≦0.4, 0<y≦0.4, and x+y+z=1.

For example, the lithium transition metal oxide in the composite cathode active material may be represented by Formula 6:

Liₐ[NiₓCo_{y}Al_{z}Zr_{w}]O₂. Formula 6

In Formula 6, 0.9<a≦1.1, 0.8≦x<1, 0<y≦0.4, 0<y≦0.4, 0≦w<0.05, and x+y+z+w=1.

For example, the lithium transition metal oxide in the composite cathode active material may be represented by Formula 7:

Liₐ[NiₓCo_{y}Al_{z}Zr_{w}]O₂. Formula 7

In Formula 7, 0.9<a≦1.1, 0.8≦x<1, 0<y≦0.2, 0<y≦0.2, 0≦w<0.05, and x+y+z+w=1.

According to another embodiment, a cathode includes the composite cathode active material described above.

The cathode may be prepared, for example, by molding a cathode active material composition including the composite cathode active material and a binder into a shape or by coating a current collector of a copper foil or an aluminum foil with the cathode active material composition.

For example, a cathode active material composition may be prepared by mixing the composite cathode active material, a conducting agent, a binder, and a solvent. A cathode plate may be prepared by directly coating and drying a metal current collector with the cathode active material composition. As another example, the cathode active material composition may be cast on a separate support, and then a metal current collector may be laminated with a film and detached from the support to prepare a cathode plate. The cathode is not limited to the configurations described above and may have other configurations and may be made by other methods.

In some embodiments, in addition to the composite cathode active material, the cathode may include any additional cathode active material suitable for lithium batteries, for example a cathode active material having a feature that is different from the cathode active material described herein, such as a different composition or a particle diameter, from that of the composite cathode active material.

In some embodiments, the additional cathode active material may be one or more selected from a lithium cobalt oxide, a lithium nickel cobalt manganese oxide, a lithium nickel cobalt aluminum oxide, a lithium iron phosphorous oxide, and a lithium manganese oxide. However, the additional cathode active material is not limited thereto and any suitable cathode active material may be further included.

For example, the cathode active material may be a compound represented by one of the following formulas: LiₐA_{1-b}B_{b}D₂ (where, 0.90≦a≦1.8 and 0≦b≦0.5); LiₐE_{1-b}B_{b}O_{2-c}D_{c} (where, 0.90≦a≦1.8, 0≦b≦0.5, and 0≦c≦0.05); LiE_{2-b}B_{b}O_{4-c}D_{c} (where, 0≦b≦0.5 and 0≦c≦0.05); LiₐNi_{1-b-c}Co_{b}B_{c}D_{α} (where, 0.90≦a≦1.8, 0≦b≦0.5, 0≦c≦0.05, and 0<α≦2); LiₐNi_{1-b-c}Co_{b}B_{c}O_{2-α}F_{α} (where, 0.90≦a≦1.8, 0≦b≦0.5, 0≦c≦0.05, and 0<α<2); LiₐNi_{1-b-c}Co_{b}B_{c}O_{2-α}F₂ (where, 0.90≦a≦1.8, 0≦b≦0.5, 0≦c≦0.05, and 0<α<2); LiₐNi_{1-b-c}Mn_{b}B_{c}D_{α} (where, 0.90≦a≦1.8, 0≦b≦0.5, 0≦c≦0.05, and 0<α≦2); LiₐNi_{1-b-c}Mn_{b}B_{c}O_{2-α}F_{α} (where, 0.90≦a≦1.8, 0≦b≦0.5, 0≦c≦0.05, and 0<α<2); LiₐNi_{1-b-c}Mn_{b}B_{c}O_{2-α}F₂ (where, 0.90≦a≦1.8, 0≦b≦0.5, 0≦c≦0.05, and 0<α<2); LiₐNi_{b}E_{c}G_{d}O₂ (where, 0.90≦a≦1.8, 0≦b≦0.9, 0≦c≦0.5, and 0.001≦d≦0.1); LiₐNi_{b}Co_{c}Mn_{d}GeO₂ (where, 0.90≦a≦1.8, 0≦b≦0.9, 0≦c≦0.5, 0≦d≦0.5, and 0.001≦e≦0.1); LiₐNiG_{b}O₂ (where, 0.90≦a≦1.8 and 0.001≦b≦0.1); LiₐCoG_{b}O₂ (where, 0.90≦a≦1.8 and 0.001≦b≦0.1); LiₐMnG_{b}O₂ (where, 0.90≦a≦1.8 and 0.001≦b≦0.1); LiₐMn₂G_{b}O₄ (where, 0.90≦a≦1.8 and 0.001≦b≦0.1); QO₂; QS₂; LiQS₂; V₂O₅; LiV₂O₅; LiIO₂; LiNiVO₄; Li_{(3-f)}J₂(PO₄)₃(0≦f≦2); Li_{(3-f)}Fe₂(PO₄)₃(0≦f≦2); and LiFePO₄. In these formulas, A is Ni, Co, Mn, or a combination thereof; B is Al, Ni, Co, Mn, Cr, Fe, Mg, Sr, V, rare earth elements, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof.

In some embodiments, the additional cathode active material may include a compound represented by one of the above formulas having a coating layer coated thereon. In some embodiments, the additional cathode active material may include a compound represented one of the above formulas and another compound, the other compound having a coating layer coated thereon. The coating layer may include a compound including a coating element (e.g., an oxide, hydroxide, oxyhydroxide, oxycarbonate, or hydrocarbonate of the coating element). The compound forming the coating layer may be amorphous or crystalline. The coating element included in the coating layer may be Mg, Al, Co, K, Na, Ca, Si, Ti, V, Sn, Ge, Ga, B, As, Zr, or a mixture thereof. Any suitable coating method may be used for a process of forming a coating layer as long as coating may be performed by using a method (e.g., spray coating or dipping) that does not (or substantially does not) adversely affect the physical properties of the cathode active material.

In some embodiments, the cathode active material may be LiNiO₂, LiCoO₂, LiMnₓO₂ₓ (where, x=1, 2), LiNi₁₋ₓMnₓO₂ (where, 0<x<1), LiNi_{1-x-y}CoₓMn_{y}O₂ (where, 0≦x≦0.5 and 0≦y≦0.5), LiFeO₂, V₂O₅, TiS, or MoS.

In some embodiments, carbon black and fine graphite particles may be used as the conducting agent, but the conducting agent is not limited thereto, and any other suitable conducting agent used in lithium batteries may be utilized. Non-limiting examples of the conducting agent include graphite such as natural graphite or artificial graphite; carbon black such as acetylene black, KETJENBLACK® (e.g. KETJENBLACK® EC-300J, KETJENBLACK® EC-600JD (pellets or powder), and/or KETJENBLACK® EC-330 JMA, each available from Akzo Nobel N.V.), channel black, furnace black, lamp black, or thermal black; conductive fibers such as carbon fibers or metal fibers; metal powder such as fluorocarbon powder, aluminum powder, or nickel powder; conductive whiskers such as a zinc oxide or a potassium titanate; a conductive metal oxide such as a titanium oxide; and a conductive material such as a polyphenylene derivative.

Non-limiting examples of the binder include vinylidene fluoride/hexafluoropropylene copolymer, polyvinylidene fluoride (PVDF), polyacrylonitrile, polymethylmethacrylate, polytetrafluoroethylene, a mixture of on or more of these binders, a styrene butadiene rubber-based polymer, and any other suitable binder used in lithium batteries.

Non-limiting examples of the solvent may include N-methylpyrrolidone, acetone, and water. Other suitable solvents include any solvent or solvent mixture used in lithium batteries.

In some embodiments, any suitable amounts of the composite cathode active material, the conducting agent, the binder, and the solvent may be used, for example, amounts suitable for a lithium battery. One or more of the conductive agent, the binder, and the solvent may be omitted according to particular applications and configurations of lithium batteries.

According to another embodiment, a lithium battery includes a cathode including the composite cathode active material. The lithium battery may be prepared according to the following method.

First, a cathode may be prepared by using the method of preparing a cathode described above.

Next, an anode active material, a conducting agent, a binder, and a solvent may be mixed to prepare an anode active material composition. An anode plate may be prepared by directly coating and drying a metal current collector with the anode active material composition. In some embodiments, the anode active material composition may be cast on a separate support, and then a metal current collector is laminated with a film detached from the support to prepare an anode plate.

The anode active material is not particularly limited, and any suitable anode active material used in lithium batteries may be utilized. Non-limiting examples of the anode active material include a lithium metal, a metal or semi-metal alloyable with lithium, a transition metal oxide, a transition metal sulfide, a material capable of doping and dedoping lithium, a material capable of reversibly intercalating and deintercalating lithium ions, and a conductive polymer.

Non-limiting examples of the transition metal oxide include a tungsten oxide, a molybdenum oxide, a titanium oxide, a lithium titanium oxide, a vanadium oxide, and a lithium vanadium oxide. Non-limiting examples of the transition metal oxide include a group I metal containing compound such as CuO, Cu₂O, Ag₂O, CuS, and CuSO₄; a group IV metal containing compound such as TiS₂ and SnO; a group V metal containing compound such as V₂O₅, V₆O₁₂, VOₓ(0<x<6), Nb₂O₅, Bi₂O₃, and Sb₂O₃; a group VI metal containing compound such as CrO₃, Cr₂O₃, MoO₃, MoS₂, WO₃, and SeO₂; a group VII metal containing compound such as MnO₂ and Mn₂O₃; a group VIII metal containing compound such as CrO₃, Cr₂O₃, MoO₃, MoS₂, WO₃, and SeO₂; a compound represented by the general formula LiₓMN_{y}X₂ (where, M and N are group I to VIII metals, X is oxygen or sulfur, 0.1≦x≦2, and 0≦y≦1); and a lithium titanate (such as Li_{y}TiO₂ (where, 0≦y≦1), Li_{4+y}Ti₅O₁₂ (where, 0≦y≦1), or Li_{4+y}Ti₁₁O₂₀ (where, 0≦y≦1)).

Non-limiting examples of the material capable of doping and dedoping lithium include Si, SiOₓ (where, 0<x<2), an Si—Y alloy (where Y is an alkali metal, an alkali earth metal, a Group 13 element, a Group 14 element (excluding Si), a transition metal, a rare earth element, or a combination thereof), a Sn—Y alloy (where Y is an alkali metal, an alkali earth metal, a Group 13 element, a Group 14 element (excluding Sn), a transition metal, a rare earth element, or a combination thereof), and MnOx (where 0<x≦2). Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or a combination thereof. Non-limiting examples of the oxide of the metal or semi-metal alloyable with lithium include a lithium titanium oxide, a vanadium oxide, a lithium vanadium oxide, SnO₂, and SiOx (where 0<x<2).

The material capable of reversibly intercalating and deintercalating lithium ions may include a carbon-based material such as a carbon-based anode active material suitably used in lithium batteries. Non-limiting examples of the material capable of reversibly intercalating and deintercalating lithium ions include crystalline carbon, amorphous carbon, and a mixture thereof. The crystalline carbon may be natural graphite or artificial graphite in amorphous plate form, flake form, spherical form, and/or fibrous form. The amorphous carbon may be, for example, soft carbon (e.g., carbon sintered at low temperature), hard carbon, meso-phase pitch carbides, or sintered cokes.

Non-limiting examples of the conductive polymers include disulfide polymers, polypyrroles, polyanilines, poly-p-phenylenes, polycaetylenes, and polyacenes.

In some embodiments, in the anode active material composition, the conductive agent, a binder, and a solvent may be selected from those already described with respect to cathode active material composition. In some embodiments, a plasticizer may be added to the cathode active material composition and/or the anode active material composition, for example, to form pores in the cathode or anode plate.

The amounts of the negative electrode active material, the conducting agent, the binder, and the solvent include any suitable amounts, for example amounts suitably used in the manufacture of a lithium battery. In some embodiments, one or more of the conducting agent, the binder and the solvent may be excluded according to the use and the structure of a particular lithium battery.

In some embodiments, a separator is disposed between the cathode and the anode. The separator may be any separator that is suitably used in lithium batteries. The separator may have low resistance to migration of ions in an electrolyte and/or may have suitable electrolyte-retaining ability. Non-limiting examples of the separator include a glass fiber, a polyester, Teflon, polyethylene, polypropylene, polytetrafluoroethylene (PTFE), and a combination thereof, each of which may be in the form of a non-woven or woven fabric. For example, a rollable separator including polyethylene or polypropylene may be used. A separator with a good organic electrolyte solution-retaining ability may be used for a lithium ion polymer battery.

By way of example, the separator may be manufactured in the following manner. A polymer resin, a filler, and a solvent may be mixed together to prepare a separator composition. Then, the separator composition may be directly coated on an electrode, and dried to form the separator. As another example, the separator composition may be cast on a support and then dried to form a separator film, which may then be separated from the support and laminated on an electrode to form the separator.

The polymer resin used to manufacture the separator may be any material that is suitably used as a binder for electrode plates. Non-limiting examples of the polymer resin include a vinylidenefluoride/hexafluoropropylene copolymer, polyvinylidene fluoride (PVDF), polyacrylonitrile, polymethylmethacrylate, and a mixture thereof.

In some embodiments, an electrolyte for the lithium battery is a liquid electrolyte. The liquid electrolyte may be an organic electrolyte solution. The organic electrolyte solution may be prepared by dissolving a lithium salt in an organic solvent.

The organic solvent may be any organic solvent suitable for the manufacture of a lithium battery. Non-limiting examples of the organic solvent include propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxorane, 4-methyldioxorane, N,N-dimethyl formamide, dimethyl acetamide, dimethylsulfoxide, dioxane, 1,2-dimethoxyethane, sulforane, dichloroethane, chlorobenzene, nitrobenzene, diethylene glycol, dimethyl ether, and mixtures thereof.

The lithium salt may include any suitable lithium salt, e.g. a lithium salt suitable for manufacturing a lithium battery. Non-limiting examples of the lithium salt include LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein x and y are each independently 1 to 20), LiCl, LiI, and a mixture thereof.

In some embodiments, the electrolyte may be a solid electrolyte such as an organic solid electrolyte or an inorganic solid electrolyte. When a solid electrolyte is used, the solid electrolyte may also serve as a separator and may thus be used to manufacture a lithium battery without using the separator as described above.

Non-limiting examples of the organic solid electrolyte include a polyethylene derivative, a polyethylene oxide derivative, a polypropylene oxide derivative, a phosphate ester polymer, a polyagitation lysine, a polyester sulfide, a polyvinyl alcohol, a polyvinylidene fluoride, and a polymer including an ionic dissociation group (e.g., a polymer including a group with a dissociable ion, such as a salt).

Non-limiting examples of the inorganic solid electrolyte include a boron oxide, a lithium oxynitride, and any suitable solid electrolyte for lithium batteries. The solid electrolyte may be formed on the anode by using a method such as sputtering. Non-limiting examples of the inorganic solid electrolyte include a nitride, a halide, or a sulfate of Li (such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, or Li₃PO₄—Li₂S—SiS₂).

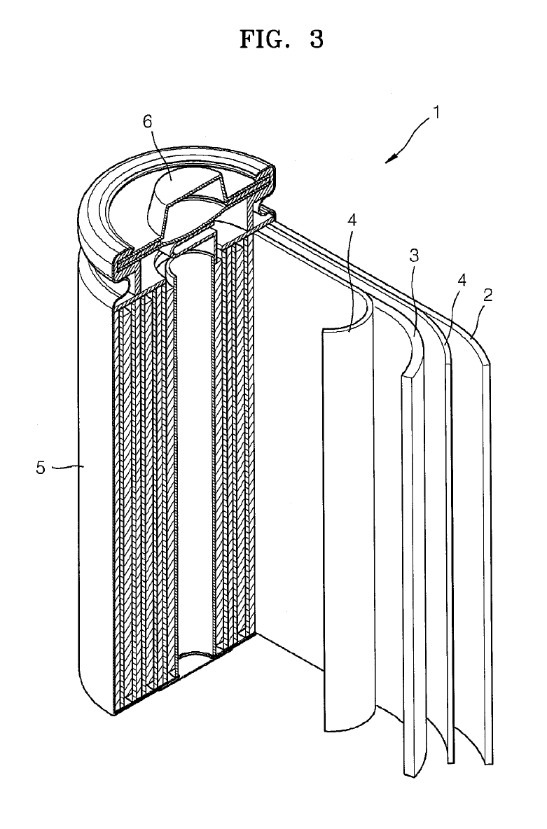

Referring to FIG. 3, a lithium battery 1 includes a cathode 3, an anode 2, and a separator 4. The cathode 3, the anode 2 and the separator 4 may be wound or folded, and then sealed in a battery case 5. Then, the battery case 5 may be filled with an organic electrolyte solution and sealed with a cap assembly 6, thereby completing the manufacture of the lithium battery 1. The battery case 5 may be a cylindrical shape, a rectangular shape, or a thin-film battery case. For example, the lithium battery 1 may be a thin-film battery. The lithium battery 1 may be a lithium ion battery.

The separator 4 may be disposed between the cathode 3 and the anode 2 to form a battery assembly. Alternatively, the battery assembly may be stacked in a bi-cell structure and impregnated with the electrolyte solution. The resultant is put into a pouch and sealed, thereby completing the manufacture of a lithium ion polymer battery.

In some embodiments, a plurality of battery assemblies may be stacked in series to form a battery pack, which may be used, for example, in a device that requires high capacity and high output, such as a laptop computer, a smart phone, an electric tool, or an electric vehicle.

According to some embodiments, the lithium battery has improved cycle life characteristics and stability and thus may be used to manufacture medium-large sized energy storage device. For example, the lithium battery may be used as a power source in an electric vehicle (EV), for example, a hybrid vehicle such as a plug-in hybrid electric vehicle (PHEV).

In some embodiments, a method of preparing a composite cathode active material includes preparing a lithium transition metal oxide having a layered structure and heat-treating the lithium transition metal oxide.

A temperature for the heat-treating in the method may be of from about 600° C. to about 900° C. For example, a temperature for the heat-treating in the method may be about 700° C. to about 800° C. When the heat-treating temperature is lower than 600° C., crystalline raw materials may not react, and when the heat-treating temperature is higher than 900° C., an undesired amount of phase transition may occur.

A period of time for the heat-treating in the method may be about 5 hours to about 25 hours. When the heat-treating time is less than 5 hours, a spinel structural phase may not be formed, and when the heat-treating time is over 25 hours, cycle life characteristics of a lithium battery including the composite cathode active material may be deteriorated.

The heat-treating in the method may be performed under an oxidative atmosphere. The oxidative atmosphere is not particularly limited, and any oxidative atmosphere including air or oxygen may be available.

In some embodiments, the composite cathode active material may be prepared as follows.

A lithium transition metal oxide having a layered structure may be prepared by co-precipitating a transition metal precursor in a mixture solution including transition metal precursors and a pH adjusting agent to obtain a precipitate, mixing the precipitate with a lithium precursor, and heat-treating the mixture. The precipitate may be a transition metal hydroxide and/or a transition metal oxyhydroxide.

In some embodiments, the transition metal precursor may be a nickel source, a cobalt source, and/or an aluminum source. The nickel source may be a nickel sulfate and/or a nickel acetate, but the nickel source is not limited thereto, and any suitable nickel source may be used. The cobalt source may be at least one selected from CoCO₃, Co(SO₄), Co₃O₄, Co(OH)₂, and CoO, but the cobalt source is not limited thereto, and any suitable cobalt source may be used. The aluminum source may be Al(OH)₃, Al₂O₃, and/or AlCI₃, but the aluminum source is not limited thereto, and any suitable aluminum source may be used. The lithium precursor may be Li₂CO₃ or LiOH, but the lithium precursor is not limited thereto, and any suitable lithium precursor may be used.

In some embodiments, in the method, the pH adjusting agent may be a sodium hydroxide or a potassium hydroxide. For example, in the method, a pH of the mixture solution may be about 9 to about 11.5. When a pH of the mixture solution is lower than 9, a particle diameter of the cathode active material precursor may be increased too far, and thus additional pulverization may be needed to decrease the particle size. When a pH of the mixture solution is higher than 11.5, a particle diameter of the cathode active material precursor may be decreased to far, and thus filtration may be difficult due to the small particle size.

In some embodiments, an oxidizing agent and/or a reducing agent may be additionally used in the method. The oxidizing agent may be hydrogen peroxide or hypochlorite of an alkali metal, but the oxidizing agent is not limited thereto, and any suitable oxidizing agent may be used. In the method, the reducing agent may be an inorganic reducing agent or an organic reducing agent.

In some embodiments, in the method, the mixture (i.e., the solution mixture prior to heat-treatment) may additionally include a complexing agent. The complexing agent is not particularly limited as long as the complexing agent is suitable to form a chelate with transition metal ions in the mixture. Non-limiting examples of the complexing agent include ammonium hydroxide, ammonium sulfate, ammonium chlorate, ammonium carbonate, ammonium fluoride, and ethylenediamine acetate.

A temperature of the heat-treatment after mixing the precipitate with the lithium precursor is not particularly limited, but the temperature may be, for example, about 600° C. to about 900° C. For example, a temperature of the heat-treatment after mixing the precipitate with the lithium precursor may be about 700° C. to about 800° C. For example, a temperature for a primary heat-treatment after mixing the precipitate and the lithium precursor may be about 700° C. to about 800° C. A period of time for the heat-treatment is not particularly limited but may be, for example, about 1 hour to about 25 hours.

In some embodiments, the lithium transition metal oxide having a layered structure may be heat-treated again to allow phase transition of some of the layered structures to spinel structures to prepare the composite cathode active material. For example, the lithium transition metal oxide having a layered structure obtained after the primary heat-treatment may undergo a secondary heat-treatment, and a temperature of the secondary heat-treatment may be about 600° C. to about 900° C. For example, a temperature for the secondary heat-treatment may be about 700° C. to about 800° C. For example, a temperature for the secondary heat-treatment may be about 750° C. to about 800° C.

Embodiments of present invention will be described in further detail with reference to the following examples. These examples are for illustrative purposes only and are not intended to limit the scope of the present invention.

### Preparation of Composite Cathode Active Material

### Comparative Example 1

### Composite Cathode Active Material

A composite cathode active material precursor prepared by using a co-precipitation method and a lithium hydroxide hydrate (LiOH·H₂O) were mixed to provide a molar ratio of a transition metal and lithium of about 1.0:1.06, and primary heat-treatment was performed on the mixture in an electric furnace under an oxygen atmosphere at a temperature of 780° C. for 5 hours to prepare a composite cathode active material that is represented by Li_{1.06}[Ni_{0.93}CO_{0.06}Al_{0.01}]O₂ having a layered structure.

The composite cathode active material was washed and filtered, and secondary heat-treatment was performed on the composite cathode active material in an electric furnace under an oxygen atmosphere at a temperature of 780° C. for 5 hours to prepare a composite cathode active material having a layered structural phase and a spinel structural phase.

### Example 1

A cathode active material was prepared in the same manner as in Comparative Example 1, except that the secondary heat-treatment was performed for 10 hours.

### Example 2

A cathode active material was prepared in the same manner as in Comparative Example 1, except that the secondary heat-treatment was performed for 15 hours.

### Example 3

A cathode active material was prepared in the same manner as in Comparative Example 1, except that the secondary heat-treatment was performed for 20 hours.

### Example 4

A cathode active material was prepared in the same manner as in Comparative Example 1, except that the secondary heat-treatment was performed for 24 hours.

### Example 5

A cathode active material was prepared in the same manner as in Comparative Example 1, except that the secondary heat-treatment was performed for 30 hours.

### Preparation of Cathode and Lithium Battery: Coin Half-Cell

### Comparative Example 2

An active material slurry was prepared by mixing an active material prepared in Comparative Example 1, a carbon conducting agent and a binder, in which the weight ratio of the active material prepared in Comparative Example 1 to a carbon conducting agent to a binder was 94:3:3. The resulting slurry was coated on an aluminum current collector having a thickness of about 15 μm at a thickness of about 80 gin by using a doctor blade, dried at a temperature of about 120° C. for 3 hours or more, and then pressed to prepare a cathode plate having a thickness of about 120 μm.

The cathode plate, a lithium metal as a counter electrode, and a solution including a polyethylene separator (STAR 20, Asahi) and 1.3 M of LiPF₆ dissolved in a mixed solvent of ethylenecarbonate (EC)+ethylmethylcarbonate (EMC)+dimethylcarbonate (DMC) (at a volume ratio of 3:3:4) as an electrolyte were used to prepare a 2016-type coin half-cell.

### Examples 6 to 10

Each of cathode and lithium battery was prepared in the same manner as in Comparative Example 2, except that each of the composite cathode active materials prepared in Examples 1 to 5 was used instead of the composite cathode active materials prepared in Comparative Example 1.

### Evaluation Example 1

### XRD Measurement

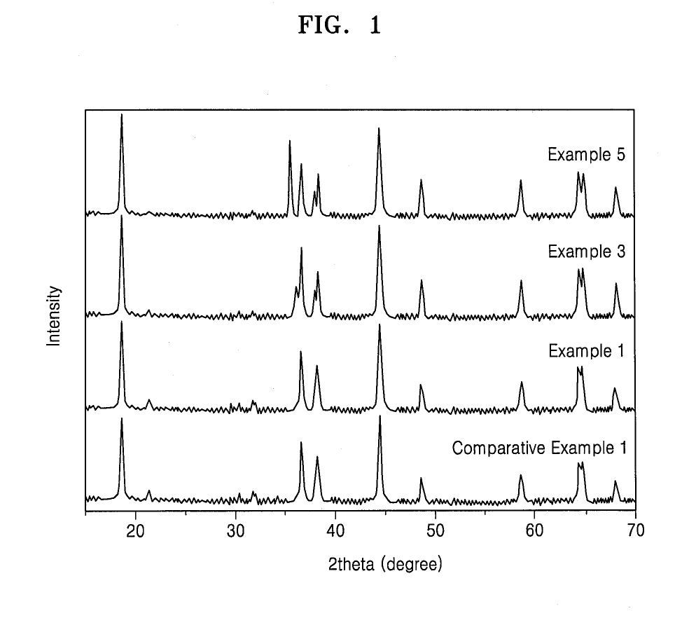

X-ray diffraction (XRD) spectra of the composite cathode active material prepared in Examples 1 to 5 and Comparative Example 1 were measured, and some of the results are shown in FIG. 1. The XRD was carried out by using model: sdik-j1-066 available from Philips. An X-ray source was Cu kα radiation at 8048 eV.

As shown in FIG. 1, the composite cathode active materials prepared in Examples 1, 3, and 5 had a first peak at a diffraction angle (2θ) in a range of about 35° to about 37°. The first peak corresponds to a spinel structural phase.

On the other hand, the cathode active material precursor prepared in Comparative Example 1 only had a peak that corresponds to the composite cathode active material having a layered structure.

### Evaluation Example 2

### Measurement of Spinel Structure Content

A Ni-filter was installed in a sealed Cu tube, which is an X-ray generating device. Then, XRD spectrum was obtained at a tube current of about 40 mA, a tube voltage of about 40 kV, a scanning speed of about 0.1 degree/step, and a scanning range of about 35° to about 38° for detection of a diffraction ray of a spinel structure.

Peak area integration method (EVA) and profile fitting (TOPAS) were each performed on the obtained XRD spectrum to compare the results. The profile fitting was performed by using a fundamental parameter which is appropriate when the background is not a straight line, and the peak of a spinel structure was analyzed to obtain a vol % of a spinel structure phase in the total crystalline structure phase. The results are shown in Table 1.

TABLE 1

| | Spinel structure content |
|---|---|
| | [vol %] |
| Comparative | 0 |
| Example 1 | |
| Example 1 | 0.6 |
| Example 2 | 1.1 |
| Example 3 | 2.0 |
| Example 4 | 3.4 |
| Example 5 | 7.0 |

As shown in Table 1, the composite cathode active materials prepared in Examples 1 to 5 had a spinel structural phase in addition to the layered structure phase.

### Evaluation Example 3

### Measurement of Residual Lithium

Powders of the composite cathode active material prepared in Examples 1 to 5 and Comparative Example 1 were dissolved in water, and the solution was filtered. The filtered solution was titrated with hydrochloric acid to calculate contents of LiOH and Li₂CO₃ in each of the composite cathode active material powders, and a content of lithium remained on a surface of the lithium transition metal oxide was obtained from the calculated result. The results are shown in Table 2.

TABLE 2

| | Residual lithium |
|---|---|
| | [wt %] |
| Comparative | 0.34 |
| Example 1 | |
| Example 1 | 0.25 |
| Example 3 | 0.16 |
| Example 5 | 0.19 |

As shown in Table 2, the composite cathode active materials prepared in Examples 1, 3, and 5 had contents of residual lithium that were reduced in the coating layer compared to that of the composite cathode active material prepared in Comparative Example 1. When a content of residual lithium in a composite cathode active material is reduced, potential side reaction with an electrolyte may be reduced.

### Evaluation Example 5

### Evaluation of Charging/Discharging Characteristics

Lithium batteries prepared after the heat-treatment were charged at a constant current of 0.5 C rate until a voltage reached about 4.3 V (vs. Li), and constant-voltage charge was performed until a current reached about 0.5 C while the voltage was maintained at about 4.3 V. Subsequently, constant-current discharge was performed at about 0.5 C until the voltage reached about 2.8 V (vs. Li) during the discharge as one cycle, and the cycle was performed 100 times.

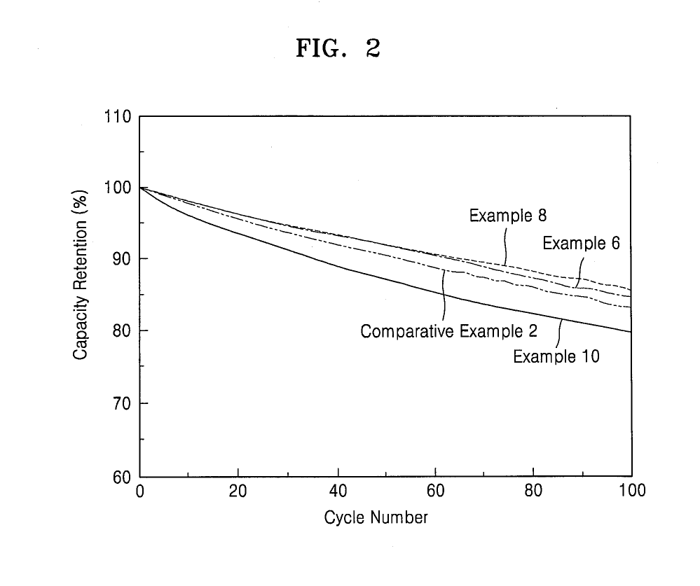

Results of performing the charging/discharging cycles are shown in Table 3 and FIG. 2. A capacity retention rate is represented by Equation 1.

A capacity retention rate [%]=[a discharge capacity at 100^{th} cycle/a discharge capacity at 1^{st} cycle]×100 Equation 1

TABLE 3

| | A capacity retention |
|---|---|
| | rate at 100^{th} cycle |
| | [%] |
| Comparative | 83.3 |
| Example 2 | |
| Example 6 | 84.7 |
| Example 7 | 85.1 |
| Example 8 | 85.8 |
| Example 9 | 83.5 |
| Example 10 | 79.9 |

As shown in Table 3 and FIG. 2, the lithium batteries prepared in Examples 6 to 9 had improved cycle life characteristics compared to that of the lithium battery prepared in Comparative Example 2. The lithium batteries prepared in Examples 6 to 9 had decreased initial discharge capacities compared to that of the lithium battery prepared in Comparative Example 2, but overall discharge capacities of the lithium batteries prepared in Examples 6 to 9 increased as shown by the increased capacity retention rates.

As described above, according to one or more of the above embodiments, a lithium battery may include a composite cathode active material including a lithium transition metal oxide having both a layered structure and a spinel structure to improve life characteristics of the lithium battery.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the present invention and/or equivalents thereof.

What is claimed is:

1. A composite cathode active material comprising:
a lithium transition metal oxide comprising a layered structural phase and a spinel structural phase, wherein an amount of residual lithium in the lithium transition metal oxide is about 0.30 wt % or less.

2. The composite cathode active material of claim 1, wherein an X-ray diffraction spectrum of the lithium transition metal oxide shows a first peak at a diffraction angle (2θ) of about 35° to about 37° corresponding to the spinel structural phase.

3. The composite cathode active material of claim 1, wherein an amount of the spinel structural phase is about 5.0 vol % with respect to the total volume of crystalline structural phase.

4. The composite cathode active material of claim 1, wherein an amount of the spinel structural phase is about 0.5 vol % to about 5.0 vol % with respect to the total volume of crystalline structural phase.

5. The composite cathode active material of claim 1, wherein an amount of the spinel structural phase is about 0.6 vol % to about 3.5 vol % with respect to the total volume of crystalline structural phase.

6. The composite cathode active material of claim 1, wherein the spinel structural phase is formed by phase transitioning the layered structural phase.

7. The composite cathode active material of claim 1, wherein the phase transitioning is performed by heat-treating the layered structural phase.

8. The composite cathode active material of claim 1, wherein the amount of residual lithium in the lithium transition metal oxide is about 0.28 wt % or less.

9. The composite cathode active material of claim 1, wherein the amount of residual lithium in the lithium transition metal oxide is about 0.25 wt % or less.

10. The composite cathode active material of claim 1, wherein the lithium transition metal oxide is represented by Formula 1:
LiₐMO_{2+α} Formula 1
wherein, in Formula 1,
0.9<a≦1.1 and −0.1≦α≦0.1; and
M is at least one element selected from the group consisting of Ni, Co, Mn, Fe, V, Cu, Cr, Al, Mg, Ti, Ca, Mg, Al, Sr, Zn, Y, Zr, Nb, and B.

11. The composite cathode active material of claim 1, wherein the lithium transition metal oxide comprises nickel in an amount higher than any other transition metal in the lithium transition metal oxide.

12. The composite cathode active material of claim 1, wherein the lithium transition metal oxide is represented by Formula 2:
Liₐ[NiₓM′_{b}]O_{2+α} Formula 2
wherein, in Formula 2,
0.9<a≦1.1, 0.6≦x<1, 0<b≦0.4, x+y=1, and −0.1≦α≦0.1; and
M′ is at least one selected from the group consisting of Co, Mn, Fe, V, Cu, Cr, Al, Mg, Ti, Ca, Mg, Al, Sr, Zn, Y, Zr, Nb, and B.

13. The composite cathode active material of claim 1, wherein the lithium transition metal oxide is represented by Formula 3:
Liₐ[NiₓCo_{y}Al_{z}A_{w}]O_{2+α} Formula 3
wherein, in Formula 3,
0.9<a≦1.1, 0.6≦x<1, 0<y≦0.4, 0<z≦0.4, 0≦w<0.05, x+y+z+w=1, and −0.1≦α≦0.1; and
A is at least one selected from the group consisting of Fe, V, Cu, Cr, Mn, Mg, Ti, Ca, Mg, Al, Sr, Zn, Y, Zr, Nb, and B.

14. The composite cathode active material of claim 1, wherein the lithium transition metal oxide is represented by Formula 4:
Liₐ[NiₓCo_{y}Al_{z}]O₂ Formula 4
wherein, in Formula 4,
0.9<a≦1.1, 0.8≦x<1, 0<y≦0.4, 0<z≦0.4, and x+y+z+w=1.

15. A cathode comprising the composite cathode active material of claim 1.

16. A lithium battery comprising the cathode of claim 15.

17. A method of preparing a composite cathode active material, the method comprising:
preparing a lithium transition metal oxide having a layered structure; and
heat-treating the lithium transition metal oxide to provide the composite cathode active material, the composite cathode active material comprising a lithium transition metal oxide having a layered structural phase and a spinal structural phase.

18. The method of claim 17, wherein the lithium transition metal oxide is heat-treated at a temperature of about 600° C. to about 900° C.

19. The method of claim 17, wherein the lithium transition metal oxide is heat-treated for about 5 hours to about 25 hours.

20. The method of claim 17, wherein the lithium transition metal oxide is heat-treated in an oxidative atmosphere.
